(19) United States
(12) Patent Application Publication
(10) Pub. No.: US 2007/0222729 A1
(43) Pub. Date: Sep. 27, 2007

(54) LIQUID CRYSTAL DISPLAY DEVICE

(76) Inventors: Kazuhiro Nishiyama, Kanazawa-shi (JP); Mitsutaka Okita, Hakusan-shi (JP); Daiichi Suzuki, Sendai-shi (JP); Shigesumi Araki, Ishikawa-gun (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/689,079

(22) Filed: Mar. 21, 2007

(30) Foreign Application Priority Data
Mar. 22, 2006 (JP) 2006-079171

(51) Int. Cl. G09G 3/36

(52) U.S. Cl. 345/88

(57) ABSTRACT

A liquid crystal display device includes liquid crystal pixels which perform display of different color components, a driver which drives the liquid crystal pixels according to a video signal which expresses gradations of the color components, and a video signal processor which corrects the video signal to keep a color gamut substantially constant in a range from a maximum gradation to a specified intermediate gradation.

### CROSS-REFERENCE TO RELATED APPLICATIONS

This application is based upon and claims the benefit of priority from prior Japanese Patent Application No. 2006-079171, filed Mar. 22, 2006, the entire contents of which are incorporated herein by reference.

### BACKGROUND OF THE INVENTION

1. Field of the Invention

This invention relates to a liquid crystal display device in which a plurality of liquid crystal pixels display different color components of, for example, red, green and blue.

2. Description of the Related Art

A flat-panel display device represented by a liquid crystal display device is widely used in a computer, car navigation system, TV receiver or the like to display an image. The liquid crystal display device generally includes a liquid crystal display panel having a matrix array of liquid crystal pixels, a backlight which illuminates the liquid crystal display panel, and a display control circuit which controls the display panel and backlight. The liquid crystal display panel has a structure in which a liquid crystal layer is held between an array substrate and a counter-substrate.

The array substrate includes a plurality of pixel electrodes arrayed substantially in a matrix, a plurality of gate lines arranged along the rows of pixel electrodes, a plurality of source lines arranged along the columns of pixel electrodes, and a plurality of switching elements arranged near intersections between the gate lines and the source lines. For example, each of the switching elements is composed of a thin-film transistor (TFT), and is turned on when one gate line is driven, thereby applying the potential of a corresponding source line to one pixel electrode. On the counter-substrate, a common electrode is provided in opposition to the pixel electrodes arrayed on the array substrate. The pixel electrode and common electrode of one pair constitute a pixel together with a pixel area which is part of the liquid crystal layer located between the above electrodes. The liquid crystal molecular alignment in the pixel area is controlled by an electric field between the pixel electrode and the common electrode. The display control circuit includes a gate driver which drives the gate lines, a source driver which drives the source lines, and a controller circuit which controls the gate driver, source driver and backlight.

When the liquid crystal display device is used for a TV receiver, which principally displays moving images, the introduction of a liquid crystal display panel of an OCB mode in which liquid crystal molecules exhibit a good response characteristic (refer to Jpn. Pat. Appln. KOKAI Publication No. 2002-202491), has been studied. In the liquid crystal display panel, liquid crystal is set in a splay alignment in which the liquid crystal molecules are almost lies down before supply of power by alignment films that are provided on the pixel electrode and the common electrode and are rubbed in parallel direction. The liquid crystal display panel performs a display operation after the splay alignment of the liquid crystal molecules is transitioned to a bend alignment by a relatively intense electric field applied in the initialization process upon supply of power.

Conventional liquid crystal display devices generally have a color gamut of 70.8% (sRGB standard) or 71.7% (EBU standard) against NTSC color space. The color gamut is expressed by an area ratio obtained with respect to outputs of red 100%, green 100% and blue 100% on the xy chromaticity coordinate diagram. However, in the liquid crystal display devices, the color purity of a single color varies with the gradation. More specifically, since the color purity is lowered upon decrease in the gradation, the color gamut also becomes narrow due to the decrease in the gradation. That is, the color gamut varies with the gradation.

### BRIEF SUMMARY OF THE INVENTION

An object of this invention is to provide a liquid crystal display device which can realize a uniform color gamut for a wide gradation range.

According to one aspect of this invention, there is provided a liquid crystal display device comprising a plurality of liquid crystal pixels which perform display of different color components, a driver which drives the liquid crystal pixels according to a video signal which expresses gradations of the color components, and a video signal processor which corrects the video signal to keep a color gamut substantially constant in a range from a maximum gradation to a specified intermediate gradation.

In the liquid crystal display device, the color gamut is kept substantially constant in the range from the maximum gradation to the specified intermediate gradation by causing the video signal processor to correct the video signal. Thus, a uniform color gamut is realized for a wide gradation range. Therefore, a video image can be displayed without causing a viewer to have a feeling that something is wrong.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated In and constitute a part of the specification, illustrate embodiments of the invention, and together with the general description given above and the detailed description of the embodiments given below, serve to explain the principles of the invention.

FIG. 1 is a diagram schematically showing the circuit configuration of a liquid crystal display device according to one embodiment of this invention;

FIG. 2 is a cross sectional view showing the cross-sectional structure of the liquid crystal display panel shown in FIG. 1; and

FIG. 3 is a diagram showing relationships between an input gradation value of each of red-, green- and blue-component signals and gradation values of the other color component signals which should be additionally provided with respect to the input gradation value in a correction process performed by a video signal processing circuit shown in FIG. 1.

### DETAILED DESCRIPTION OF THE INVENTION

A liquid crystal display device according to one embodiment of this invention will be described below with reference to the accompanying drawings.

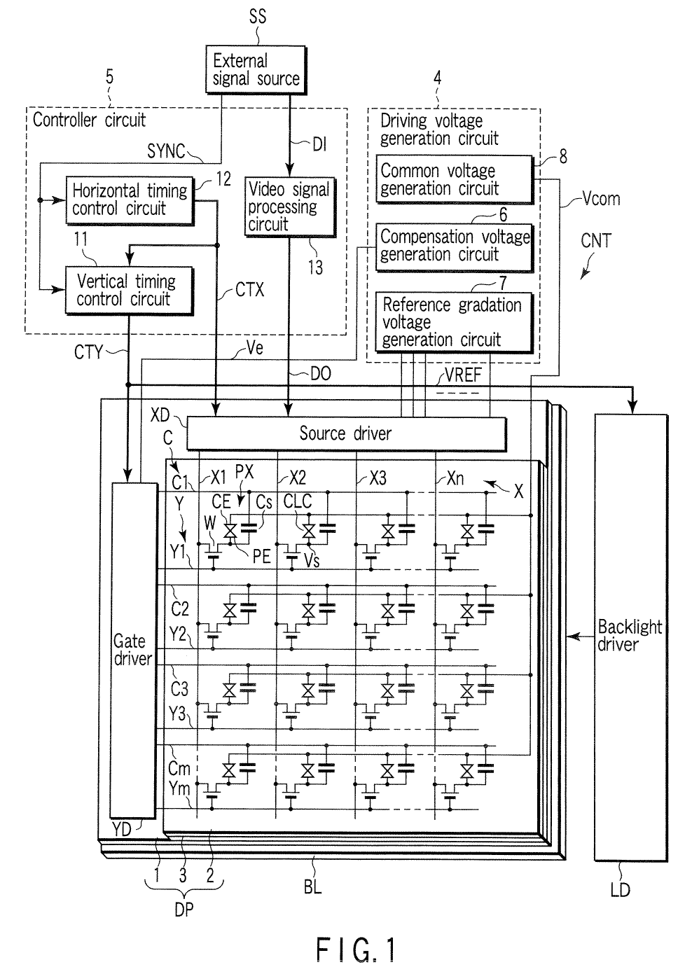

FIG. 1 schematically shows the circuit configuration of the liquid crystal display device. The liquid crystal display device includes a liquid crystal display panel DP of an OCB mode which is suited for display of moving images in a TV receiver or the like, a backlight BL which illuminates the display panel DP, and a display control circuit CNT which controls the display panel DP and backlight BL. For example, the backlight BL is an LED backlight which includes red, green, and blue light-emitting diodes (LEDs) assembled as a light source and capable of realizing high color purity. In place of the above LEDs, three-wavelength type LEDs may be suitably used as the light source. The liquid crystal display panel DP has a structure in which a liquid crystal layer 3 is held between an array substrate 1 and a counter-substrate 2 serving as a pair of electrode substrates. For example, the liquid crystal layer 3 contains a liquid crystal material which is previously transitioned from a splay alignment to a bend alignment to perform the display operation of normally white and to which a high voltage such as a black-display voltage is periodically applied to prevent reverse-transition from the bend alignment to the splay alignment. The display control circuit CNT controls light transmittance of the liquid crystal display panel DP by use of a liquid crystal drive voltage applied to the liquid crystal layer 3 from the array substrate 1 and counter-substrate 2. Transition from the splay alignment to the bend alignment is attained by applying a relatively intense electric field to the liquid crystal material in a predetermined initialization process performed by the display control circuit CNT upon supply of power.

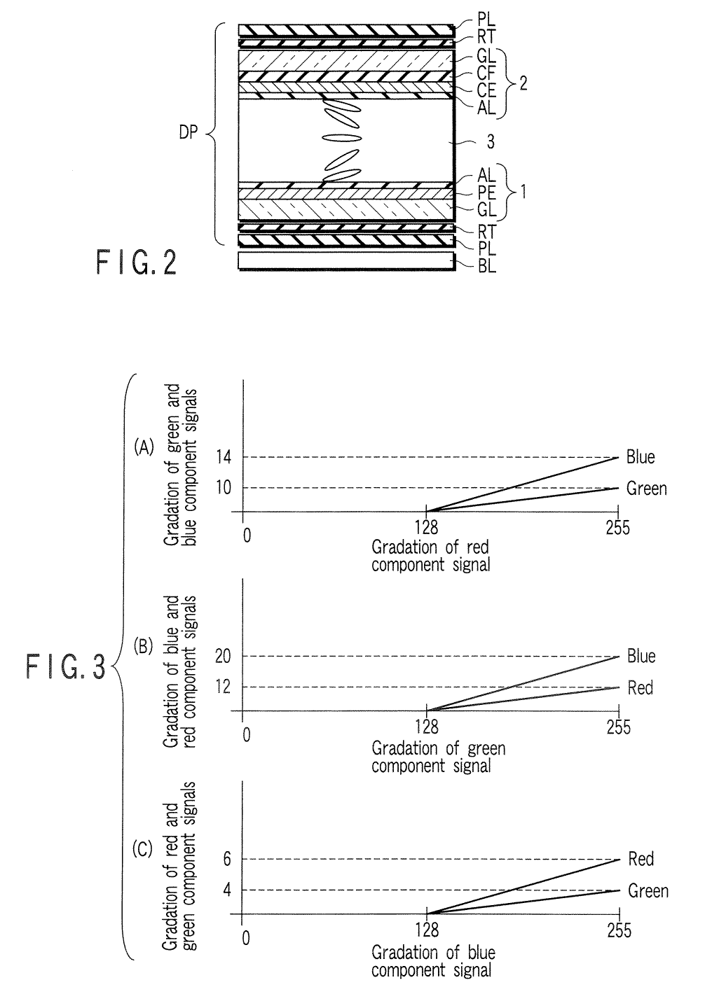

FIG. 2 shows the cross-sectional structure of the liquid crystal display panel DP in detail. The array substrate 1 includes a transparent insulating substrate GL formed of a glass plate or the like, a plurality of pixel electrodes PE formed on the transparent insulating substrate GL, and an alignment film AL formed on the pixel electrodes PE. The counter-substrate 2 includes a transparent insulating substrate GL formed of a glass plate or the like, a color filter layer CF formed on the transparent insulating substrate GL, a common electrode CE formed on the color filter layer CF and an alignment film AL formed on the common electrode CE. The liquid crystal layer 3 is obtained by filling the liquid crystal material into a gap between the counter-substrate 2 and the array substrate 1. For example, the color filter layer CF includes strips of red-colored, green-colored and blue-colored layers which are arranged in a row direction and located over the columns of pixel electrodes PE. In FIG. 2, the liquid crystal molecules are set in a splay alignment state. Further, the liquid crystal display panel DP has a pair of retardation films RT disposed outside the array substrate 1 and counter-substrate 2, a pair of polarizers PL disposed outside the retardation films RT and a backlight BL for a light source disposed outside the polarizer PL disposed on the array substrate 1. The alignment film AL on the array substrate 1 and the alignment film AL on the counter-substrate 2 are rubbed in parallel directions. As a result, the pre-tilt angle of the liquid crystal molecules is set to approximately 10°.

In the array substrate 1, the pixel electrodes PE are arrayed in substantially a matrix on the transparent insulating substrate GL. Further, a plurality of gate lines Y (Y1 to Ym) are arranged along the rows of pixel electrodes PE and a plurality of source lines X (X1 to Xn) are arranged along the columns of pixel electrodes PE. A plurality of pixel switching elements W are arranged near intersections between the gate lines Y and the source lines X. Each of the pixel switching elements W is composed, for example, of a thin-film transistor which has a gate connected to a corresponding gate line Y and a source-drain path connected between a corresponding source line X and a corresponding pixel electrode PE, and is turned on between the corresponding source line X and the corresponding pixel electrode PE when it is driven via the corresponding gate line Y.

The pixel electrodes PE and the common electrode CE are each formed of a transparent electrode material such as ITO, and are covered with the alignment films AL, respectively. The pixel electrode and common electrode of each pair constitute a liquid crystal pixel PX together with a pixel area which is part of the liquid crystal layer 3, in which the alignment of the liquid crystal molecules is controlled by an electric field created between the pixel electrode PE and common electrode CE. In this case, the liquid crystal pixels PX of each row face the red-colored layer, green-colored layer and blue-colored layer for every three pixels to constitute red, green and blue pixels that perform display of different color components of red, green and blue. The red, green and blue pixels constitute a color pixel that performs display of a color corresponding to a combination of gradations of the color components of red, green and blue. The liquid crystal pixels PX have liquid crystal capacitances CLC each present between a corresponding pixel electrode PE and the common electrode CE. Each of storage capacitance lines C1 to Cm is capcitively coupled with the pixel electrodes PE of the liquid crystal pixels PX of a corresponding row to constitute storage capacitances Cs.

The display control circuit CNT includes a gate driver YD which sequentially drives the gate lines Y1 to Ym to turn on the switching elements W in units of one row, a source driver XD which outputs pixel voltages Vs to the source lines X1 to Xn for a period in which the switching elements W of each row are driven via the corresponding gate line Y and kept conductive, a backlight driver LD which drives the backlight BL, a driving voltage generation circuit 4 which generates voltages required for driving of the display panel DP, and a controller circuit 5 which controls the gate driver YD, source driver XD and backlight driver LD.

The driving voltage generation circuit 4 includes a compensation voltage generation circuit 6 which generates a compensation voltage Ve to be applied to the storage capacitance line C via the gate driver YD, a reference gradation voltage generation circuit 7 which generates a preset number of reference gradation voltages VREF to be used by the source driver XD, and a common voltage generation circuit 8 which generates common voltage Vcom to be applied to the counter-electrode CT. The controller circuit 5 includes a vertical timing control circuit 11 which generates a control signal CTY to the gate driver YD based on a sync signal SYNC input from an external signal source SS, a horizontal timing control circuit 12 which generates a control signal CTX to the source driver XD based on the sync signal SYNC input from the external signal source SS, and a video signal processing circuit 13 which processes a video signal DI for the pixels PX input in a digital form from the external signal source SS. The control signal CTY is supplied to the gate driver YD, and the control signal CTX is supplied to the source driver XD together with processing results from the video signal processing circuit 13. The control signal CTY is used to control the above-mentioned operation of the gate driver YD for sequentially driving the gate lines YD, and the control signal CTX is used to control the operation of the source driver XD for assigning the source lines X to the processing results from the video signal processing circuit 13 which are obtained in units of the liquid crystal pixels PX of one row and output in series as a video signal DO and for specifying the output polarity.

Under the control of the control signal CTY, the gate driver YD sequentially selects the gate lines Y1 to Ym and supplies a turn-on voltage to the selected gate line Y as a drive signal which turns on the pixel switching elements W of a corresponding row. The source driver XD converts the video signal DO into pixel voltages Vs with reference to the preset number of reference gradation voltages VREF supplied from the reference gradation voltage generation circuit 7 and outputs the pixel voltages Vs to the source lines X1 to Xn in parallel.

The pixel voltage Vs is voltage applied to the pixel electrode PE with the common voltage Vcom of the common electrode CE used as a reference, and the polarity thereof is inverted with respect to the common voltage Vcom to perform an operation of frame inversion driving and line inversion driving, for example. The compensation voltage Ve is applied via the gate driver YD to one of the storage capacitance lines C which corresponds to the gate line Y connected to the switching elements W of one row when these switching elements W are turned off, and is used to compensate for variation in the pixel voltage Vs occurring in the pixels PX of one row due to the parasitic capacitances of the switching elements W.

Since the color gamut of the liquid crystal display panel DP tends to become narrower due to the decrease in the gradation, the video signal processing circuit 13 is configured to perform a correction process of correcting the video signal DI so that the color gamut will become substantially constant in a range from the maximum gradation to a specified intermediate gradation. The video signal DI contains red, green and blue component signals respectively representing gradations of red, green and blue that define a color to be displayed by a color pixel. If each color component signal of the video signal DI is formed of 8 bits and the total gradation number represented by the color component signal is 256 from the 0^{th} gradation to 255^{th} gradation, the specified intermediate gradation is set to the 128^{th} gradation which is decreased from the 255^{th} gradation which is the maximum gradation by ½ of the total gradation number, for example. In the correction process, the red-, green- and blue-component signals are extracted from the video signal DI for the red pixels, green pixels and blue pixels, and each of these color component signals is used for correction of the other color component signals. Specifically, when any of the red-, green- and blue-component signals, for example, the red-component signal represents a gradation equal to or more than the 128^{th} gradation, the green- and blue-component signals which are treated as the other color component signals in this case are increased by the correction process and output as a processing result. The color gamut is kept constant as a result of mixing the green and blue components with the red component in such a manner that the green- and blue-component signals of 2% are output when the red-component signal of 100% is output, and the green- and blue-component signals of 1.8% are output when the red-component signal of 95% is output. In FIG. 3, (A) indicates gradation values of the green- and blue-component signals which should be additionally provided with respect an input gradation value of the red-component signal, (B) indicates gradation values of the red- and blue-component signals which should be additionally provided with respect to an input gradation value of the green-component signal, and (C) indicates gradation values of the red- and green-component signals which should be additionally provided with respect to an input gradation value of the blue-component signal. It is understood that when any of the input gradation values of the red-, green- and blue-component signals becomes equal to or more than the 128^{th} gradation, the other color component signals are increased by the correction process.

The video signal processing circuit 13 includes a memory which holds a correction rule defined by the relationships shown in FIG. 3, and converts the color component signals extracted from the video signal DI to implement the correction rule.

According to this embodiment, each color pixel of the liquid crystal display panel DP is constituted by red, green and blue pixels. When the gradation represented by any of red-, green-, and blue-component signals for the red, green and blue pixels falls within a range from the maximum gradation to a specified intermediate gradation, the gradations represented by the other color component signals are increased to attain a mixture of red, green and blue components that keeps the color gamut substantially constant in the range from the maximum gradation to the specified intermediate gradation. Thus, a uniform color gamut is realized for a wide gradation range. Further, a mixture of the other color components increases the luminance, a fine image can be displayed on the liquid crystal display panel DP.

The above-mentioned configuration is suited for the case where display is carried out based on a TV signal supplied as the video signal. In general, it is desired that the color gamut is wide. However, if the color gamut is too wide in the case where display is carried out base on the TV signal, many viewers will have a feeling that something is wrong. Therefore, although the color gamut becomes slightly narrower, uniformity thereof is realized as a whole in the present embodiment, thereby increasing the luminance. With the increase in the luminance, the viewability is enhanced without causing the viewers to have a feeling that something is wrong.

Further, the video signal processing circuit 13 may be controlled by an external selection signal such that the signal processing is performed when a TV signal is input as the video signal and is omitted when a computer-created signal is input as the video signal.

With this control, when a TV signal is input as the video signal, an excellent image can be displayed by a uniform color gamut and high luminance realized for the TV signal. Further, when a computer-created signal is input as the video signal, a wide color gamut can be attained for the computer-created signal.

The aforementioned color mixture ratio is not limited to the value used in the above embodiment and can be set to various values suitable for the color display characteristic and luminance characteristic of the liquid crystal display panel DP and the LED backlight. It is preferable that a large number of gradations is present in the range from the maximum gradation to the specified intermediate gradation in order to attain a uniform color gamut. However, to keep such a uniform color gamut satisfactory, it is preferable that the specified intermediate gradation is not decreased below ½ of the maximum gradation (i.e., the 128^{th} gradation when 256 gradations are provided). To have an effect of the uniform color gamut, it is preferable that the specified intermediate gradation is not decreased below ¼ of the maximum gradation (i.e., the 192^{th} gradation when 256 gradations are provided).

This invention is not limited to the above embodiment and can be variously modified without departing from the technical scope thereof.

For example, the video signal processing circuit 13 is configured to further perform the correction process of correcting the video signal DI to keep a chrominance (color difference) constant between the maximum gradation and the specified intermediate gradation at the single color display time since the color purity in the chromaticity coordinate diagram of red, green and blue of the liquid crystal display panel DP tends to be lowered due to the decrease in the gradation. If each color component signal of the video signal DI is formed of 8 bits and the total gradation number represented by the color component signal is 256 from the 0^{th} gradation to 255^{th} gradation, the specified intermediate gradation is set to the 128^{th} gradation which is decreased from the 255^{th} gradation, which is the maximum gradation, by ½ of the total gradation number, for example. In the correction process, the red-, green- and blue-component signals is extracted from the video signal DI for the red pixels, green pixels and blue pixels, and each of these color component signals is used for correction of the other color component signals. Specifically, when any of the red-, green- and blue-component signals, for example, the red-component signal represents a gradation equal to or more than the 128^{th} gradation, the green- and blue-component signals which are treated as the other color component signals in this case are increased by the correction process and output as a processing result. The color gamut is kept constant as a result of mixing the green and blue components with the red component in such a manner that the green- and blue-component signals of 2% are output when the red-component signal of 100% is output, and the green- and blue-component signals of 1.8% are output when the red-component signal of 95% is output. In this case, like the case of (A), (B) and (C) of FIG. 3, when the input gradation value of any of the green- and blue-component signals becomes equal to or more than the 128^{th} gradation, the other color components signals are increased by the correction process.

According to the above modification, each color pixel of the liquid crystal display panel DP is constituted by red, green and blue pixels. When the gradation represented by any of red-, green-, and blue-component signals for the red, green and blue pixels falls within a range from the maximum gradation to a specified intermediate gradation, the gradations represented by the other color component signals are increased to attain a mixture of red, green and blue components that keeps a chrominance (color difference) constant between gradations. Thus, a fine image can be displayed on the liquid crystal display panel DP.

The aforementioned color mixture ratio is not limited to the value used in the above modification and can be set to various values suitable for the color display characteristic and luminance characteristic of the liquid crystal display panel DP and the LED backlight. It is preferable that a small number of gradations is present in the range from the maximum gradation to the specified intermediate gradation in order to attain color stability in a wide gradation range. The color stability is attainable in a wide gradation range as the result of color mixing by the correction process even when the number of gradations is set to ¼ of the total gradation number or ½ (i.e., the 128^{th} gradation when 256 gradations are provided).

In the above embodiment and modification, the liquid crystal display panel DP of the OCB mode is used, but this invention is also applicable to a TN (Twist Nematic) mode, VA (Vertical Alignment) mode and IPS (In-Plane Switching) mode. In this case, it is preferable to use an LED backlight as the backlight BL as in the above embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid crystal display device comprising:
a plurality of liquid crystal pixels which perform display of different color components;
a driver which drives the liquid crystal pixels according to a video signal which expresses gradations of the color components; and
a video signal processor which corrects the video signal to keep a color gamut substantially constant in a range from a maximum gradation to a specified intermediate gradation.

2. The liquid crystal display device according to claim 1, wherein the video signal is corrected to keep a chrominance constant between the maximum gradation and the specified intermediate gradation at single color display time.

3. The liquid crystal display device according to claim 1, wherein the video signal contains a plurality of color component signals respectively representing gradations of the color components and the video signal processor is configured such that each of the color component signals is used to correct the other color component signals.

4. The liquid crystal display device according to claim 3, wherein when the gradation represented by any of the color component signals is not lower than the specified intermediate gradation, the gradations represented by the other color component signals are increased.

5. The liquid crystal display device according to claim 4, wherein the specified intermediate gradation is set to a gradation decreased from the maximum gradation by substantially half of the total gradation number expressed by each color component signal.

6. The liquid crystal display device according to claim 4, wherein the specified intermediate gradation is a gradation decreased from the maximum gradation by substantially ¼ of the total gradation number expressed by each color component signal.

7. The liquid crystal display device according to claim 1, wherein the color components correspond to at least red, green and blue.

8. The liquid crystal display device according to claim 1, wherein the liquid crystal pixels are illuminated by a backlight which includes light-emitting diodes assembled as a light source.

9. The liquid crystal display device according to claim 1, correction of the video signal is selectively performed under the control of an external selection signal.
